(19) United States
(12) Patent Application Publication
(10) Pub. No.: US 2011/0146272 A1
(43) Pub. Date: Jun. 23, 2011

(54) DIESEL ENGINE FOR A MOTOR VEHICLE

(75) Inventors: Federico FERRERO, Caselette (IT); Alessandra CHIANALE, Alpignano (IT); Michael POTTER, Condove (IT); Federico Luigi GUGLIELMONE, Rivoli (IT); Lorenzo MAGRO, Torino (IT)

(73) Assignee: GM GLOBAL TECHNOLOGY OPERATIONS, INC., Detroit, MI (US)

(21) Appl. No.: 12/950,437

(22) Filed: Nov. 19, 2010

(30) Foreign Application Priority Data
Nov. 20, 2009 (GB) 0920374.6

(51) Int. Cl. F02M 25/07; F01N 3/033

(52) U.S. Cl. 60/605.2; 60/278

(57) ABSTRACT

A diesel engine is provided for a motor vehicle. The engine includes, but is not limited to a long route exhaust gas recirculating (LR-EGR) system, in which a Lean NOₓ Trap (LNT) is located upstream of a diesel particulate filter (DPF).

### CROSS-REFERENCE TO RELATED APPLICATION

This application claims priority to British Patent Application No. 0920374.6, filed Nov. 20, 2009, which is incorporated herein by reference in its entirety.

### TECHNICAL FIELD

The technical field relates to a Diesel engine for a motor vehicle, in particular to a Diesel engine provided with a long route exhaust gas recirculating (LR-EGR) system.

### BACKGROUND

A Diesel engine generally comprises an intake manifold, an exhaust manifold, an intake line for feeding fresh air from the environment into the intake manifold, and an exhaust line for discharging the exhaust gas from the exhaust manifold into the environment. The exhaust line normally comprises a diesel oxidation catalyst (DOC), for degrading residual hydrocarbons (HC) and carbon oxides (CO) contained in the exhaust gas, and a diesel particulate filter (DPF), located downstream the DOC, for capturing and removing diesel particulate matter (soot) from the exhaust gas.

In order to reduce NOₓ polluting emission, most turbocharged Diesel engine system actually comprises an exhaust gas recirculation (EGR) system, which is provided for routing back and mixing an appropriate amount of exhaust gas with the fresh induction air aspired into the Diesel engine. Advanced EGR systems comprise a first EGR conduit which fluidly connects the exhaust manifold with the intake manifold, and a second EGR conduit which fluidly connects the exhaust line downstream the DPF to the intake line upstream the intake manifold.

While the first EGR conduit defines a short route for the exhaust gas recirculation, the second EGR conduit defines a long route that comprises also a relevant portion of the exhaust line, including the DPF, and a relevant portion of the intake line. In this way, the long route EGR (LR-EGR) is effective for routing back to the intake manifold exhaust gas having lower temperature than that routed back by the short route EGR (SR-EGR). These advanced EGR systems are generally configured for routing back the exhaust gas partially through the SR-EGR and partially through the LR-EGR, in order to maintain the temperature of the induction air in the intake manifold at an optimal intermediate value in any engine operating condition.

Alternative way to better reduce nitrogen oxides (NOₓ) emission with higher efficiency compared to a standalone Long Route EGR circuit is to use the Selective Catalytic Reduction system (SCR). The SCR is a catalytic device in which the nitrogen oxides (NOₓ) contained in the exhaust gas are reduced into diatonic nitrogen (N₂) and water (H₂O), with the aid of a gaseous reducing agent, typically urea (CH₄N₂O), which is injected in the exhaust line and mixed with the exhaust gas upstream the SCR, to thereby being absorbed therein. The SCR is generally located in the exhaust line in under-floor position, that is downstream the DPF.

One drawback of this configuration is that the many components are generally expensive and difficult to package. Another drawback is that the SCR system requires a reservoir for the reducing agent, and that the latter has to be periodically refilled by the driver, to thereby increasing the operating costs of the vehicle.

In view of the foregoing, at least one object is to solve, or at least to positively reduce, the above mentioned drawbacks with a simple, rational and cheaper solution. In addition, other objects, desirable features and characteristics will become apparent from the subsequent summary and detailed description, and the appended claims, taken in conjunction with the accompanying drawings and this background.

### SUMMARY

An embodiment of the invention provides a Diesel engine for a motor vehicle. The engine comprises a long route exhaust gas recirculating (LR-EGR) system, in which a Lean NOₓ Trap LNT is located upstream of a Diesel Particulate Filter (DPF).

The LR-EGR system is provided for feeding into the intake manifold exhaust gas having substantially low temperature. As a matter of fact, the LR-EGR system comprises: an initial portion of the exhaust line between the exhaust manifold and a branching point downstream the DPF, to thereby including the DPF itself; a LR-EGR conduit that fluidly connects the branching point of the exhaust line to a leading point of an intake line; and a final portion of the intake line between the leading point to the intake manifold.

The Lean NOₓ Trap LNT is located in the exhaust line upstream the DPF. LNT is a catalytic device containing catalysts, such as rhodium, and absorbent, such as barium based elements, which provide active sites suitable for binding the nitrogen oxides (NOₓ contained in the exhaust gas, in order to trap them within the device itself. The LNT can be further provided with other catalysts, such as palladium and platinum, for reacting with hydrocarbon (HC) and carbon monoxide (CO) contained in the exhaust gas, in order to convert them into carbon dioxide (CO₂) and water (H₂O). In this way, the LNT effectively fulfils also the function of the DOC, which therefore is no longer necessary.

The Diesel engine has thus several important benefits with respect to the prior art. For example, a first notable benefit is that the LNT is generally cheaper than the SCR, reducing the global cost of the Diesel engine. Another example of an important benefit is that the LNT can fulfil the DOC functionalities, thus reducing the cost of having two different catalytic systems for both oxidation and reduction reactions. Furthermore, the embodiment provides a components configuration which is easier to package, if compared to the configurations of the prior art. Finally, since the LNT is located upstream the branching point of the LR-EGR conduit, the exhaust gas routed back by the latter is substantially free of nitrogen oxides (NOₓ) in any engine operating condition, thus reducing the NOx concentration at the end of the combustion process.

In another embodiment the Diesel engine further comprises a joint outer casing for the LNT and the DPF. This reduces processing time when assembling the engine and reduces packaging problems. According to another embodiment the LR-EGR system further comprises a turbocharger, which comprises a compressor located downstream the DPF in an intake line, and a turbine located in the exhaust line upstream the LNT. According to a further preferred aspect, the Diesel engine further comprises a short route EGR (SR-EGR) system.

The SR-EGR system is provided for feeding into the intake manifold exhaust gas having substantially high temperature, namely having higher temperature that that routed back by the LR-EGR. As a matter of fact, the SR-EGR system comprises a SR-EGR conduit that directly fluidly connects the exhaust manifold to the intake manifold.

### BRIEF DESCRIPTION OF THE DRAWINGS

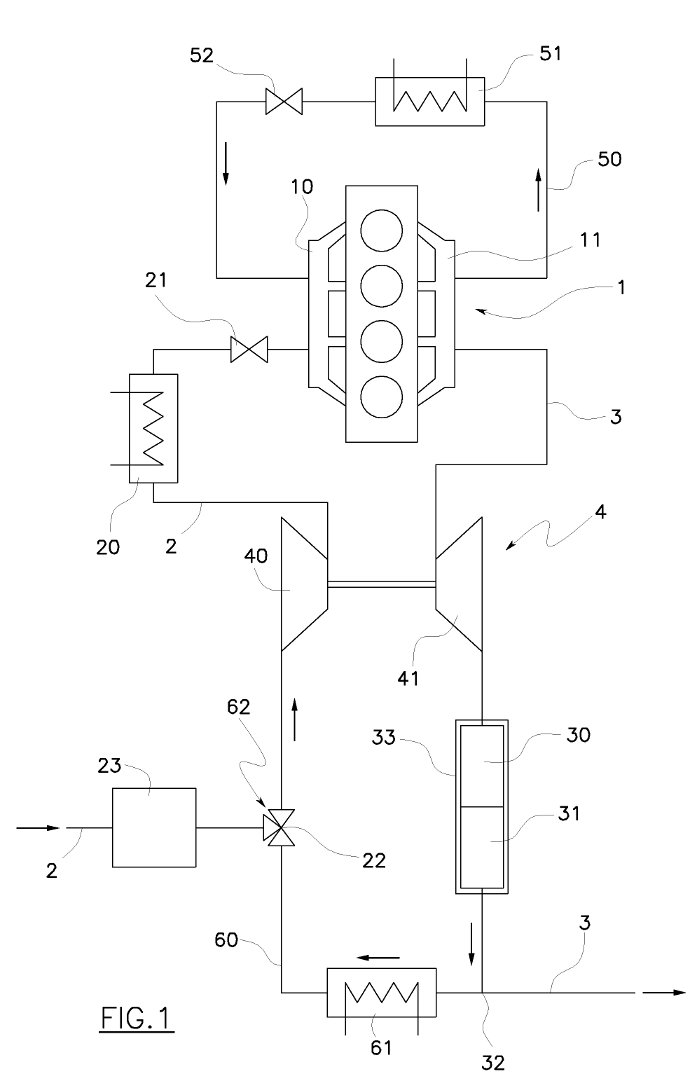

The present invention will hereinafter be described in conjunction with the following drawing FIG. 1, which schematically illustrates a turbocharged Diesel engine system according to an embodiment of the invention.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The Diesel engine 1, which is preferably a turbocharged Diesel engine, comprises an intake manifold 10 and an exhaust manifold 11, an intake line 2 for feeding fresh air from the environment in the intake manifold 10, an exhaust line 3 for discharging the exhaust gas from the exhaust manifold 11 into the environment, and a turbocharger 4 which comprises a compressor 40 located in the intake line 2, for compressing the air stream flowing therein, and a turbine 41 located in the exhaust line 3, for driving said compressor 40. A Diesel engine 1, which is preferable a turbocharged diesel engine, further comprises an intercooler 20, also indicated as Charge Air Cooler (CAC), located in the intake line 2 downstream the compressor 40 of turbocharger 4, for cooling the air stream before it reaches the intake manifold 10, and a throttle valve 21 located in the intake line between the CAC 20 and the intake manifold 10. The Diesel engine 1 further comprises a diesel particulate filter (DPF) 31 located in the exhaust line 3, for capturing and removing diesel particulate matter (soot) from the exhaust gas.

In order to reduce polluting emission, the Diesel engine 1 comprises an exhaust gas recirculation (EGR) system, for routing back and feeding exhaust gas into the Diesel engine 1 itself. The EGR system comprise a first EGR conduit 50 for fluidly connecting the exhaust manifold 11 with the intake manifold 10, a first EGR cooler 51 for cooling the exhaust gas, and a first electrically controlled valve 52 for determining the flow rate of exhaust gas through the first EGR conduit 51. Since the first EGR conduit 51 directly connects the exhaust manifold 11 with the intake manifold 10, it defines a short route EGR (SR-EGR) system which routes back high temperature exhaust gas.

The EGR system further comprise a second EGR conduit 60, which fluidly connects a branching point 32 of the exhaust line 3 with a leading point 22 of the intake line 2, and a second EGR cooler 61 located in the second EGR conduit 60. The branching point 32 is located downstream the DPF 31, and the leading point 22 is located downstream an air filter 23 and upstream the compressor 40 of turbocharger 4. The flow rate of exhaust gas through the second EGR conduit 60 is determined by a second electrically controlled three-way valve 62, which is located in the leading point 22. As a matter of fact, the EGR systems is provided with a long route EGR (LR-EGR) system, which comprises the initial portion of the exhaust line 3 between the Diesel engine 1 to the branching point 32, including the turbine 41 of turbocharger 4 and the DPF 31; the second EGR conduit 60, including the second EGR cooler 61; and the final portion of the intake line 2 between the leading point 22 and the Diesel engine 1, including the second valve 62, the compressor 40 of turbocharger 4, the CAC 20, and the throttle valve 21. Flowing along the long route EGR, the exhaust gas becomes considerably colder than the exhaust gas which flows through the first EGR conduit 50, to thereby reaching the intake manifold 10 at a lower temperature.

The turbocharged Diesel engine system is operated by a microprocessor based controller (ECU), which is provided for generating and applying control signals to the valves 52 and 62, in order to route back the exhaust gas partially through the SR-EGR and partially through the LR-EGR, to thereby maintaining the temperature of the induction air in the intake manifold 10 at an optimal intermediate value in any engine operating condition.

According to an embodiment of the invention, the Diesel engine 1 further comprises a Lean NOₓ Trap (LNT) 30, which is located in the exhaust line 3 downstream the turbine 41 of turbocharger 4, and upstream the DPF 31. The LNT 30 is provided for trapping nitrogen oxides NOₓ contained in the exhaust gas. In greater detail, the LNT 30 is a device comprising a catalytic converter support, typically made of ceramic material, which has been coated with a special washcoat containing catalysts, such as for example barium and rhodium, which provide active sites suitable for binding the nitrogen oxides (NOₓ) contained in the exhaust gas, in order to trap them within the LNT 30.

According to the present example, the special washcoat of the LNT 30 further contains other catalysts, such as for example palladium and platinum, which are effective for reacting with hydrocarbon (HC) and carbon monoxide (CO) contained in the exhaust gas, in order to oxidize them into carbon dioxide (CO₂) and water (H₂O). In this way, the LNT 30 effectively fulfils the function of a conventional DOC, which therefore is not necessary. According to another embodiment, the LNT 30 is accommodated into an outer casing 33 which accommodates also the DPF 31, to thereby forming a single component.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary or detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A diesel engine, comprising:
a diesel particulate filter;
a long route exhaust gas recirculating system; and
a Lean NOₓ Trap of the long route exhaust gas recirculating system located upstream of the diesel particulate filter.

2. The diesel engine according to claim 1, further comprising a joint outer casing for the Lean NOₓ Trap.

3. The diesel engine according to claim 1, further comprising a joint outer casing for the diesel particulate filter.

4. The diesel engine according to claim 1, further comprising a joint outer casing for the Lean NOₓ Trap and the diesel particulate filter.

5. The diesel engine according to claim 1, wherein the long route exhaust gas recirculating system further comprises a turbocharger, the turbocharger comprising:
a compressor located downstream the diesel particulate filter; and
a turbine located upstream of the Lean NOₓ Trap.

6. The diesel engine according to claim 5, wherein the compressor is located downstream the diesel particulate filter in an intake line.

7. A diesel engine according to claim 1, further comprising a short route exhaust gas recirculating system.
